(19) United States
(12) Patent Application Publication
(10) Pub. No.: US 2015/0099683 A1
(43) Pub. Date: Apr. 9, 2015

(54) Non-toxic VOC free alkali surfactant and a method for floor cleaning machines

(71) Applicant: Scott C. Rhodes, Seattle, WA (US)

(72) Inventor: Scott C. Rhodes, Seattle, WA (US)

(21) Appl. No.: 14/048,327

(22) Filed: Oct. 8, 2013

(51) Int. Cl. C11D 7/26

(52) U.S. Cl. CPC C11D 7/268
USPC 510/280; 510/405

(57) ABSTRACT

Non-toxic and eco-friendly cleaning solutions include water, either sodium carbonate or sodium bicarbonate, sodium tetraborate, and alkyl polyglucoside. In some examples, the cleaning solutions include 70-98% water, 0.04-9.8% sodium carbonate or sodium bicarbonate, 0.03-8.6% sodium tetraborate, and 0.01-20% alkyl polyglucoside (having an HLB range of 10 to 20 and C.sub.8 to C.sub.16). In some further examples, the cleaning solutions include a fragrance and/or a preservative.

### BACKGROUND

The present disclosure relates generally to non-toxic, eco-friendly formulations and solutions for use in both domestic and commercial cleaning applications, for kitchens, bathrooms, carpets, textiles and general all-purpose hard surfaces free of VOCs. The proposed composition provides natural, chemically stable, and compatible cleaners, with an adjustable alkaline content dependent on use and performance. The composition comprises of natural occurring, mineral based compositions, and a plant based non-ionic surfactant.

Existing cleaners and detergents containing petroleum based or other compounds that do not disperse safely in the environment, and contain volatile organic compounds (VOCs). Further, these cleaners and detergents are harmful to humans. Many of these formulations are harsh and not naturally occurring. Most of the compositions leave residue, especially in floor machines. Over time, the toxic effects of such compositions have become more widely known, and it has become desirable to avoid exposure to such toxic materials. They can create mild to chronic symptoms with sensitive individuals, and can contain or produce known carcinogens.

Many common commercial and domestic cleaners contain VOC compounds, ammonia, chlorine, alkyl metals, phosphates or peroxide compositions which are chemically incompatible and potentially toxic, particularly with prolonged exposure or use. Acidic cleaners are incompatible with most natural stone and grout. Furthermore, the most of the aforementioned compounds are known to be damaging to downstream ecosystems.

Enzymatic based cleaners are long acting but ineffective in many commercial applications, including cleaning by floor machines, due to the time required breaking down proteins and grease. They have limited application for baked on or carbonized organic compounds. Enzyme cleaners break down in heat and UV, making there long term storage and efficacy limited, especially when used with hot water or outdoors. Enzymatic cleaners are also incompatible with organic dyes.

Thus, there exists a need for non-toxic and VOC-free cleaning solutions that improve upon and advance the design of known cleaning solutions. Examples of new and useful cleaning solutions relevant to the needs existing in the field are discussed below.

Disclosure addressing one or more of the identified existing needs is provided in the detailed description below. Examples of references relevant to cleaning solutions include U.S. Patent References: U.S. Pat. No. 4,244,834, U.S. Pat. No. 4,297,229, U.S. Pat. No. 541,813, U.S. Pat. No. 5486037, U.S. Pat. No. 5,962,399, U.S. Pat. No. 6,407,051, U.S. Pat. No. 6,432,395, U.S. Pat. No. 7,429,273, U.S. Pat. No. 7,638,474, U.S. Pat. No. 7,776,811, patent 7,829,513, and U.S. Pat. No. 8,420,584. The complete disclosures of the above patents and patent applications are herein incorporated by reference for all purposes. Some of these references are further discussed below.

While many prior patents describe solutions including sodium carbonate, and some including sodium tetraborate, none of these include alkyl polyglucoside (U.S. Pat. Nos. 4,244,834, 4,297,229). Conversely, although some prior patents describe solutions including the nonionic surfactant alkyl polyglucoside, none contain both sodium carbonate, and sodium tetraborate (U.S. Pat. Nos. 7,638,474, 6,407,051, 6,432,395, 5,415,813).

In a first example, U.S. Pat. No. 4,297,229 to Speak et al. describes a soap containing borate and bicarbonate, or alkali metal carbonate, but no alkyl polyglucoside. Further, this soap is a powder and is not in solution.

In second example, an enzymatic detergent is described in U.S. Pat. No. 8,420,584 to Thoele et al. that includes water, alkyl polyglucoside and sodium borate. It does not contain sodium carbonate or sodium bicarbonate. Further, the enzymatic detergent contains multiple additional compounds and is used for cleaning laboratory equipment.

In a third example, U.S. Pat. No. 5,415,813 to Misselyn et al. describes a solution where the major compound is alkyl polysaccharide, or alternately alkyl polyglycoside, but describes no other compounds in common with the presently described invention.

In a fourth example, carpet cleaning and deodorizing compositions are described in U.S. Pat. No. 4,244,834 to Schwalley et al. that use sodium tetraborate with ammonium and aluminosilicate salts, but no other compounds that are included in the presently described invention.

In a fifth example, natural laundry detergent compositions are described in U.S. Pat. No. 7,638,474 to Parrish et al. that use hydrogen peroxide, sodium percarbonate, and sodium perborate, as well as fatty alcohol sulfate. While some of these compounds are chemically similar, there are no compounds that are included in the presently described invention.

In a sixth example, U.S. Pat. No. 7,429,273[ to De Dominicis et al. describes a carpet cleaning method including a pre-dosed solution for carpet cleaners. The carpet cleaning solution includes water, silicone glycol copolymers, and fluorinated surfactant.

In a seventh example, an organic cleaning composition is described in U.S. Pat. No. 7,829,513 to McCarthy et al. that contains acetic acid and soybean or glycerin, and optionally polyglucoside, but no other compounds that are included in the presently described invention.

In a final example, U.S. Pat. No. 7,776,811 to Dilley et al., U.S. Pat. No. 5,486,307 to Misselyn et al., U.S. Pat. No. 6,407,051 to Smith et al., and U.S. Pat. No. 6,432,395 to Rochon et al. all describe using alkyl polyglucoside as a preferred or optional surfactant.

### SUMMARY

The present disclosure is directed to non-toxic and eco-friendly cleaning solutions (i.e., surfactants), including water, either sodium carbonate or sodium bicarbonate, sodium tetraborate, and alkyl polyglucoside. In some examples, the cleaning solutions include 70-98% water, 0.04-9.8% sodium carbonate or sodium bicarbonate, 0.03-8.6% sodium tetraborate, and 0.01-20% alkyl polyglucoside (having an HLB range of 10 to 20 and C.sub.8 to C.sub.16). In some further examples, the cleaning solutions include a fragrance and/or a preservative.

### DETAILED DESCRIPTION

The disclosed non-toxic and VOC-free cleaning solutions (i.e., surfactants) will become better understood through review of the following detailed description. The detailed description provides merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various non-toxic and VOC-free cleaning solutions are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The presently described cleaning solution is an eco-friendly and non-toxic surfactant and detergent for general cleaning, including hard surfaces, textiles, and pile textiles without toxic or VOC compounds. The surfactant contains elements specifically designed to remove dirt, grease, organic stains, fungus and mold; including baked on organic compounds. It includes solutions optimized for floor cleaning machines and laundry machines. Because the cleaning solution is non-toxic, VOC-free, and eco-friendly, the solution is less harmful to human users and their families, as well as downstream ecosystems.

Foremost, eco-friendly is defined as 99% natural occurring raw material or derived from renewable resources, such as plants. The raw materials of the invention may be obtained from 100% bio-renewable resources. Further, the components of the invention are non-toxic. Non-toxic exposure levels assume use of the invention as labeled for the intended uses. The materials and compounds used in the invention contain no USEPA method TO-15 listed or exempt VOC's compounds per 40CFR51.100. In other words, the VOC content is substantially 0%.

The invention comprises four primary components, namely: water, sodium carbonate or sodium bicarbonate, sodium tetraborate, and alkyl polyglucoside. Optional components are a fragrance and a preservative.

The first component of the cleaning solution is water. Water is a raw material used as the primary solvent and solution carrier.

The second component of the cleaning solution is sodium carbonate.

Sodium carbonate (commonly known as washing soda, soda ash, and soda crystals) is a raw material that is utilized for its properties in: removing grease, oil, stains, and odors, descaling and bonding with detergent. Sodium carbonate is also utilized for removing Cu, Fe, Ca, Zn and Pb by creating a metal carbonate precipitate. Sodium carbonate is commonly used in food and food production.

Alternatively to sodium carbonate, the second component of the cleaning solution can be sodium bicarbonate. Sodium bicarbonate (commonly known as baking soda, cooking soda, and bicarbonate of soda) is a raw material that has the above described properties of sodium carbonate, but has a lower pH. Sodium bicarbonate is a commonly held non-toxic food grade compound.

Non-toxic levels of sodium carbonate in solution (NOAELs) are 3.4 mg/kg/day for ingestion and effects on fetal rats. All other oral ingestion levels are higher for NOAELs in other human systems. (EPA 739-R-06-001) Approved EPA application rates are 2 oz/gallon for household and hospital use and 0.56 oz/gallon for food processing plants. Toxic levels of sodium carbonate in solution are unavailable from ATSDR or CDC. Sodium Carbonate is a known irritant for eyes, skin, mucous membranes, and digestive track.

The third component of the cleaning solution is sodium tetraborate. The sodium tetraborate can be either borax penahydrate or borax decahydrate. Sodium tetraborate (commonly known as borax, sodium borate, and disodium tetraborate) is a raw material that is utilized for its properties in: anti-fungal, anti-bacterial, and co-complexing characteristics as a co-surfactant. Although banned in the United States, sodium tetraborate is commonly used in food and food production.

Non-toxic levels of boron in solution, defined as no-observed-adverse-effect levels (NOAELs), are 6.1 mg/kg/day for ingestion for boron and effects on fertility and fetus development in female humans. All other oral ingestion levels are higher for NOAELs in other human systems. It is generally recognized as safe based on sea water with boron content less than 5 mg/L.

The fourth component of the cleaning solution is a low to high foam alkyl polyglucoside (polyglycoside). Alkyl polyglucoside (also known as caprylyl, decyl, coco, and lauryl polyglucoside or glucoside) is a raw material that is utilized for its properties of: low toxicity, low irritability, biodegradability, while providing superior wetting, and alkaline compatibility as a non-ionic surfactant with stable foam. The alkyl polyglucoside is optimally of 0814 or 1214 C chain variants, CAS number 161074-97-1, or 141464-42-9 or 110615-47-9 or 68515-73-1 or other variant as seen fit. Alkyl Polyglucoside is commonly used in pharmaceuticals, personal care products, food, and food production.

Non-toxic levels of alkyl polyglucoside in solution (NOAELs) are 1000 mg/kg/day for ingestion for APG and effects on fertility and fetus development in female humans. Alkyl polyglucoside is generally recognized as safe, GRAS notice number GRN 000237.

A fragrance and/or a preservative may be optionally added as desired.

The preferred but non-limiting procedure for making the non-toxic and VOC-free cleaning solutions is as follows:

First, water is filtered from a potable water utility source using a two-step cartage system of 10-50 microns and 2 microns, respectively. The water is measured at 50° Fahrenheit (F) and is then heated to 180° F.

Next, a blending vessel is filled with 82.7% water by weight, at a specific gravity of 8.34 lb/gallon. Sodium tetraborate is brought into solution by agitation until reaching 5.7% of the solution by weight. Sodium carbonate is brought into solution by agitation until reaching 8.5% of the solution by weight.

The solution is then cooled to 90° F.

After cooling, alkyl polyglucoside (APG) is integrated into the solution by agitation until reaching 3.1% by weight, assuming use of a C.sub12 to C.sub.14 variant, and the weight of only APG in a 50% water and 50% APG surfactant.

The solution is then allowed to settle. Alternatively, depending on final diluted application, the solution may not be allowed time to settle. The precipitated sodium crystal is either retained or discarded from the batch depending on desired pH and turbidity.

For cleaning solutions including sodium bicarbonate, the solution is stored in a pressure vessel.

For a 32 oz batch of cleaning solution, the weight of the primary components is as follows: 1.78 lbs of water at 50° F., 0.121 lb sodium tetraborate, 0.183 lbs of sodium carbonate or sodium bicarbonate, and 0.067 lbs of alkyl polyglucoside, assuming C.sub.12 to C.sub.14 and the weight of only APG in 50% water and 50% APG surfactant. Alternatively, the batch may be produced in any volume according to the following ranges of percentages of components: 70-98% (preferably 82-97%) water, 0.04-9.4% sodium carbonate or sodium bicarbonate, 0.03-8.6% sodium tetraborate, and 0.01-20% alkyl polyglucoside (with a HLB range of 10 to 20 and C.sub.8 to C.sub.16, but preferably C.sub.8 to C.sub.14). Preferably, the cleaning solution has a pH of 8.5 to 11.5.

For laundry machines, the concentrated base is used full strength as recommended by the manufacturer.

For carpet cleaning machines, the concentrated base invention is diluted with hot water (140-180° F.) at a ratio of 4:1 (water to concentrated cleaning solution). The diluted cleaning solution is poured into the floor cleaning machine per manufacturer's specifications. The diluted cleaning solution is applied at a rate up to 5 quarts per 1,000 sq ft with added hot water as recommended for the carpet cleaning machine. When the pile textile is scrubbed thoroughly, the inventive solution will remove most mineral, animal, or plant based stains. Scrub time is generally less than 1 minute, and nominally 10 to 30 seconds. To reduce scrubbing time, pretreatment with the inventive solution may be used and let sit for up to 30 minutes. The carpet cleaning machine is then used with only hot water to rinse pile textiles twice. An extraction rate of 90% or better is recommended due to the high volume of water, and to avoid soaking carpet backing or pad. Second rinse water may still appear dirty after rinsing. A drying time of 1-3 hours is preferred.

For a spray surfactant, general all-purpose cleaner and spot pretreatment solution, the concentrated base is diluted with water at a rate of 16:1, or alternatively, up to 30:1 (water to concentrated cleaning solution).

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A non-toxic and eco-friendly cleaning solution compound, comprising:
water;
at least one of sodium carbonate and sodium bicarbonate;
sodium tetraborate; and
an alkyl polyglucoside having the formula R—O—(CH₂)CH₃, where R is a glucose derivative, and n is an integer.

2. The cleaning solution compound of claim 1, wherein the water is 70% to 98% of the cleaning solution by weight.

3. The cleaning solution compound of claim 1, wherein the water is 82% to 97% of the cleaning solution by weight.

4. The cleaning solution compound of claim 1, wherein the at least one of sodium carbonate and sodium bicarbonate is 0.04% to 9.8% of the cleaning solution by weight.

5. The cleaning solution compound of claim 1, wherein the sodium tetraborate is 0.03% to 8.6% of the cleaning solution by weight.

6. The cleaning solution compound of claim 1, wherein the alkyl polyglucoside has an HLB range of 10 to 20 and C.sub.8 to C.sub.16, and the alkyl polyglucoside is 0.01% to 20% of the cleaning solution by weight.

7. (canceled)

8. The cleaning solution compound of claim 1, wherein the cleaning solution has a pH within the range of 8.5 to 11.5.

9. The cleaning solution compound of claim 1, wherein a VOC content is substantially 0%.

10. The cleaning solution compound of claim 1, further comprising a preservative.

11. The cleaning solution compound of claim 1, further comprising a fragrance.

12. A non-toxic and environmentally safe alkaline surfactant compound for cleaning hard surface and textiles, formulated for floor cleaning machines, comprising:
water;
at least one of sodium carbonate and sodium bicarbonate;
sodium tetraborate; and
an alkyl polyglucoside having the formula R—O—(CH₂)ₙCH₃, where R is a glucose derivative, and n is an integer.

13. (canceled)

14. The surfactant compound of claim 12, wherein the at least one of sodium carbonate and sodium bicarbonate is 0.04% to 9.8% of the cleaning solution by weight.

15. The surfactant compound of claim 12, wherein the sodium tetraborate is 0.03% to 8.6% of the cleaning solution by weight.

16. The surfactant compound of claim 12, wherein the alkyl polyglucoside has an HLB range of 10 to 20 and C.sub.8 to C.sub.14, and the alkyl polyglucoside is 0.01% to 20% of the cleaning solution by weight.

17. (canceled)

18. The surfactant compound of claim 12, wherein a VOC content is substantially 0%.

19. The surfactant compound of claim 12, further comprising one or more of a preservative and a fragrance.

20. A non-toxic and environmentally safe alkaline surfactant compound for cleaning hard surface and textiles, formulated for floor cleaning machines, comprising:
water, the water being 82% to 97% of the surfactant by weight;
at least one of sodium carbonate and sodium bicarbonate, the at least one of sodium carbonate and sodium bicarbonate being 0.04% to 9.8% of the surfactant by weight;
sodium tetraborate, the sodium tetraborate being 0.03% to 8.6% of the cleaning solution by weight; and
alkyl polyglucoside, the alkyl polyglucoside having an HLB range of 10 to 20 and C.sub.8 to C.sub.14 being either D-glucopyranose oligomeric C8-10 alkyl glycoside or D-glucopyranose oligomeric C10-16 glycoside, the alkyl polyglucoside being 0.01% to 20% of the cleaning solution by weight
wherein the surfactant has a pH within the range of 8.5 to 11.5 and a VOC content of the surfactant is substantially 0%.

21. The cleaning solution compound of claim 1, wherein the alkyl polyglucoside is D-glucopyranose oligomeric C8-10 alkyl glycoside or D-glucopyranose oligomeric C10-16 glycoside.

22. The cleaning solution compound of claim 1, wherein the alkyl polyglucoside is tetradecyl D-glucopyranoside.

23. The surfactant compound of claim 12, wherein the alkyl polyglucoside is D-glucopyranose oligomeric C8-10 alkyl glycoside or D-glucopyranose oligomeric C10-16 glycoside.

24. The cleaning solution compound of claim 12, wherein the alkyl polyglucoside is tetradecyl D-glucopyranoside.
